(19) United States
(12) Patent Application Publication
(10) Pub. No.: US 2026/0150900 A1
(43) Pub. Date: Jun. 4, 2026

(54) HEATER FOR AN AEROSOL PROVISION DEVICE

(71) Applicant: Nicoventures Trading Limited, London (GB)

(72) Inventor: Tom WOODMAN, London (GB)

(21) Appl. No.: 19/125,246

(22) PCT Filed: Oct. 30, 2023
(86) PCT No.: PCT/EP2023/080278

§ 371 Date: Apr. 28, 2025

(30) Foreign Application Priority Data
Oct. 31, 2022 (GB) 2216110.3

(51) Int. Cl. A24F 40/46; A24F 40/20; A24F 40/57

(52) U.S. Cl. CPC A24F 40/46; A24F 40/57; A24F 40/20

(57) ABSTRACT

A heater for an aerosol provision device configured to heat an article containing aerosol generating material is disclosed. The heater includes an elongate housing having a longitudinal axis and a heater element located in the elongate housing. The heater element includes a first and a second end, and at least one track of heater material extending between the first end and the second end. At least a portion of at least one track of heater material includes a change in the electrical resistance of the at least one track.

### CROSS-REFERENCE TO RELATED APPLICATIONS

This present application is a National Phase entry of PCT Application No. PCT/EP 2023/080278, filed Oct. 30, 2023, which claims priority from GB 2216110.3, filed Oct. 31, 2022, each of which are fully incorporated herein by reference in their entireties.

### TECHNICAL FIELD

The present invention relates to a heater for an aerosol provision device, an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect there is provided a heater for an aerosol provision device configured to heat an article containing aerosol generating material. The heater comprises an elongate housing having a longitudinal axis and a heater element located in the elongate housing. The heater element comprises a first and a second end, and at least one track of heater material extending between the first end and the second end. At least a portion of at least one track of heater material includes a change in the electrical resistance of the at least one track.

According to an aspect there is provided a heater for an aerosol provision device configured to heat an article containing aerosol generating material. The heater comprises an elongate housing having a longitudinal axis and a heater element located in the elongate housing. The heater element comprises a first and a second end, and a track of heater material. A length of the track of the heater material is undivided, and includes a change in the electrical resistance of the track of heater material. A length of the track of heater material is undivided if the track of heater material does not divide into two or more tracks or merge with one or more tracks.

The change in electrical resistance of the track may be such that at one side of the change the track has a first electrical resistance, and, at the other side of the change in a longitudinal direction along the track, the track has a second electrical resistance, and the first and second electrical resistances are not equal.

The change in electrical resistance of the track may be such that at one side of the change the track at least 1 mm, at least 2 mm, at least 3 mm, at least 4 mm or at least 5 mm of the track from the change in electrical resistance has a first electrical resistance, and, at least 1 mm, at least 2 mm, at least 3 mm, at least 4 mm or at least 5 mm of the track from the change in electrical resistance at the other side of the change in a longitudinal direction along the track, the track has a second electrical resistance, and the first and second electrical resistances are not equal.

The length of the first resistance and the length of the second resistance either side of the change of resistance may be different.

The difference between the first and second electrical resistances may be greater than any expected variation in electrical resistance of the heater material in a length of such material that is uniform in cross sectional area and shape along that length.

At least one track of the heater material may be divided into at least two tracks of heater material for at least a portion of the length of that track.

At least one track of the heater material may be divided into at least two tracks of heater material for at least a portion of the length of that track and merged back into a single track as a position spaced from the position of the division of the track.

In some embodiments, the at least two divided tracks do not merge back into a single track, and one end of the track comprises at least two ends of a divided track.

The at least one change of the electrical resistance of the track may be so positioned on the track that when the heater element is activated, the heater element creates a predetermined temperature profile along the length of the track. The activation of the heater element comprises energising the heater so that it causes generation of aerosol from the aerosol generating material.

The change in the electrical resistance of the track is the result of a change in a cross-section of the track.

The change of the cross-section may be a change in the cross-sectional area of the track. In such embodiments, a reduction in the cross-sectional area causes an increase in the electrical resistance of the track and consequently an increase in the temperature that the heater material reaches in the location of increased electrical resistance. An increase in the cross-sectional area causes a decrease in the electrical resistance of the track and consequently a decrease in the temperature that the heater material reaches in the location of decreased electrical resistance.

There may be at least two changes in the electrical resistance of the track.

There may be at least two changes in the electrical resistance of the track and at least one change increases the electrical resistance, and at least one change decreases the electrical resistance when traveling in the same direction from one end to the other at each change.

At least one change in electrical resistance may be a step change at a single position on the track of heater material. A single position is a very short distance along the track.

At least one change in electrical resistance may be a continuous change over a length of the track of restive material.

The heater element may further comprise a substrate, and the or each track of heater material is supported on the substrate.

The substrate and the or each track of heater material may be flexible.

The substrate may be elastically flexible.

The housing may define an inner void, and the heater element is so configured that one of at least 75%, at least 80%, at least 90% and 100% of the heater element fits within the an inner void. In some embodiments, the proportion of the heater element is measured in a direction parallel to the central axis of the inner void.

The heater element and substrate may be so configured that the substrate urges the or each track of heater material against one or more of the surfaces of the housing that define the inner void. In some embodiments the substrate may be rolled or folded into a tube, or other shape which matches the inner surface of the inner void, with the heater element on the radially outer face of the tube or other shape. The rolling or folding of the substrate and the material of the substrate may be such that the substrate has a propensity to try to reshape itself from the tube or other shape to a flatter configuration.

The heater may comprise at least one mass of a material; in which the mass of material is positioned within the inner void. The at least one mass of material may retain at least part of the heater element in a fixed position relative to the housing.

The inner void may be filled with the mass of material and the whole of the heater element that is located within the inner void is retained in a fixed position relative to the housing. The mass of material may comprise an adhesive or a potting compound.

The heater material may be a resistive heater material and the heater may be a resistive heater.

The heater may be an inductive heating heater.

The heater element may be an inductive heating element.

According to an aspect, there is provided aerosol provision device configured to heat an article comprising aerosol generating material, the device comprising a heater described above. The aerosol provision device may comprise a heating chamber, in which the heater is provided.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The aerosol provision device may be configured for wireless charging. The aerosol provision device may be provided with a charging port, such as a USB port, which is used to couple the power supply to an external power source for recharging.

According to an aspect there is provided an aerosol provision system comprising: an aerosol provision device as described above; and an article comprising aerosol generating material.

The aerosol provision system may comprise a charging unit having a cavity for removably receiving the aerosol provision device.

The charging unit may comprise a moveable lid, which covers the aerosol provision device in a closed configuration.

The charging unit may comprise a user display.

The user display may be visible to a user when the moveable lid is in a closed position and is partially or fully concealed or obscured from sight by the lid when the lid is an open position.

According to another aspect there is provided a method of generating aerosol comprising: providing an aerosol provision device comprising a heater as described above and a heating chamber including a receiving portion; and at least partially inserting an aerosol generating article into the receiving portion of the heating chamber.

The apparatus of the heater and device aspects of the present disclosure can include one or more, or all, of the features or embodiments described above, as appropriate. The method aspect of the present disclosure can include one or more, or all, of the features or embodiments described above, as appropriate

### BRIEF DESCRIPTION OF THE DRAWINGS

Various embodiments will now be described, by way of example only, and with reference to the accompanying drawings, in which:

FIG. 1 shows a perspective view of an embodiment of an aerosol provision system including an embodiment of an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of an embodiment of a heater of the device of FIG. 1 or FIG. 4;

FIG. 7 shows a first detail of a first embodiment of a heater element of the heater of FIG. 6;

FIG. 8 shows a second detail of a first embodiment of a heater element of the heater of FIG. 6;

FIG. 9 shows a first detail of a second embodiment of a heater element of the heater of FIG. 6;

FIG. 10 shows a second detail of a second embodiment of a heater element of the heater of FIG. 6;

FIG. 11 shows a detail of a third embodiment of a heater element of the heater of FIG. 6.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area or volume for receiving the consumable, an aerosol generator, an aerosol generation area or volume, a housing, a mouthpiece, a filter and/or an aerosol-modifying agent.

In some embodiments, the consumable for use with the non-combustible aerosol provision device may comprise aerosol-generating material, an aerosol-generating material storage area or volume, an aerosol-generating material transfer component, an aerosol generator, an aerosol generation area or volume, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourant.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

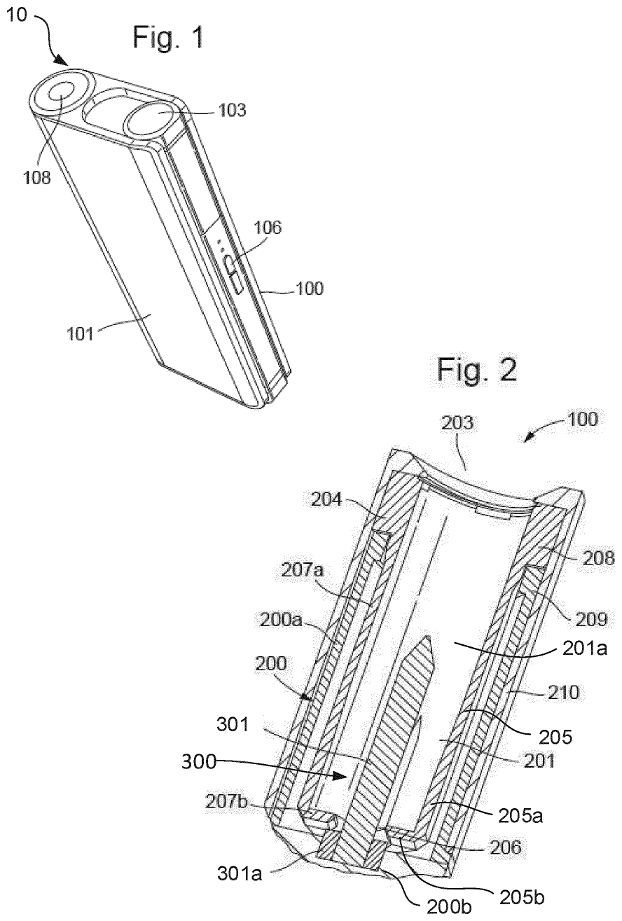

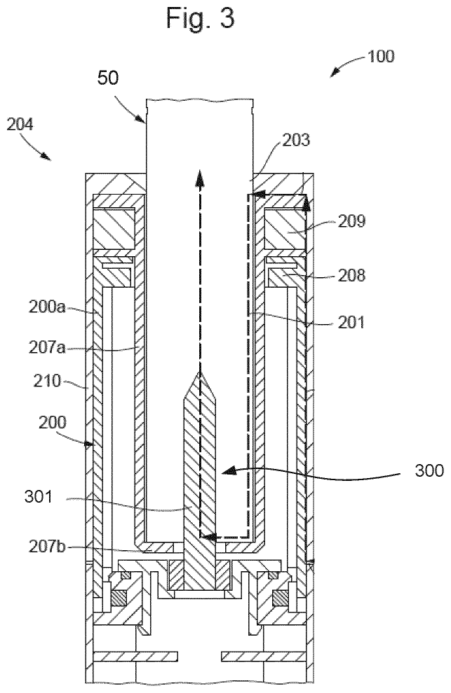

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured to receive at least a portion of the article for heating.

A heater 301 is provided in a portion of the main housing 200 and the heater 301 extends or projects into the heating chamber 201. The heater 301 may comprise a base portion 301a which may be located in a recess provided in a portion of the body of the device 100. The heater 301 upstands in the heating chamber 201. The heater 301 upstands from the distal end.

The heater 301 comprises an elongate heater in the form of a pin. The heater 301 in other embodiments comprises other elongate configurations, such as a blade. The heater 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along or parallel to the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heater 301 upstands from the housing base 200b. The heater 301 protrudes through the receptacle base 205b. An aperture 206 is formed in the receptacle base 205b through which the heater 301 protrudes. In embodiments, the heater 301 is mounted to the receptacle base 205b. The heater 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heater 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of a rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heater 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

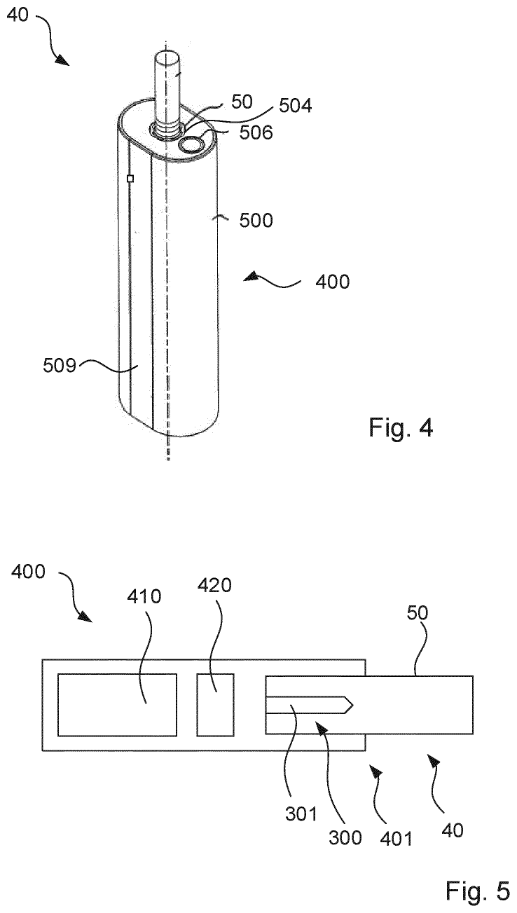

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol provision device 400 comprises a power source 410, a controller 420 and a heating chamber 401, in which the aerosol generating article 50 is removeable received

The heater 301 comprises an elongate heater in the form of a pin. The heater 301 in embodiments comprises other elongate configurations, such as a blade. The heater 301 is provided in the heating chamber. The heater 301 of FIG. 5 and the heater 301 described above with reference to FIGS. 1 to 3, such that details described herein may be applied to each. The heater 301 extends or projects into the heating chamber 401.

The heater 301 may be inserted, in use, into a distal end of the aerosol generating article which is received within the heating chamber 401 in order to internally heat the aerosol generating article.

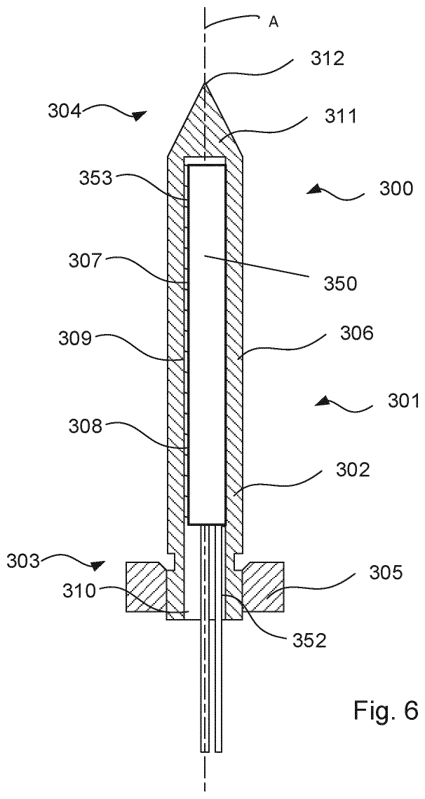

The aerosol provision devices 100, 400 comprise a heating arrangement 300. The heating arrangement 300 comprises a heater 301. The heater comprises a heater element 350 (refer to FIG. 6), arranged to be actuated to heat the heater

The heating arrangement 300 is a resistive heating arrangement. The heater 301 is a resistive heating heater. The heater element, as will be described below is at least one track of resistive heating material 351. In such arrangements the heating assembly comprises a resistive heating generator including components to heat the heater element via a resistive heating process. In this case, an electrical current is directly applied to a resistive heater element, and the resulting flow of current in the heater element, acting as a heating component, causes the heater element to be heated by Joule heating. The resistive heater element comprises resistive material configured to generate heat when a suitable electrical current passes through it, and the heating arrangement comprises electrical contacts for supplying electrical current to the resistive material. In embodiments, the heater element forms at least part of the resistive heater itself. In embodiments the resistive heater element transfers heat to the heater, for example by conduction. The provision of a resistive heating arrangement allows for a compact arrangement. Resistive heating provides an efficient configuration.

FIG. 6 shows the heater 301 for use in an aerosol provision device as described above. The heating arrangement 300 comprises the heater 301. The heater 301 comprises an elongate housing 302 and the heater element 350. The elongate housing 302 is an elongate member defining a longitudinal axis.

The housing 302 is formed from a thermally conductive material, such as aluminium. Other suitable materials, such as stainless steel or ceramic such as aluminium nitride may be used. The elongate housing may comprise a coating on its outer surface. The elongate housing 302 is configured to transfer heat from the heater element 350 to the heating zone 201a.

The elongate housing 302 has a base end 303 and a free end 304. The base end 304 mounts to the device body. A mount 305 at the base end 303 mounts the heater 301. It will be understood that different mounting arrangements may be used, for example a fixing, moulding, and bonding including adhering. The mount 305 may be a separate component or may be integrally formed with the elongate housing 302.

The elongate housing 302 comprises a housing body 306. The housing body 306 is tubular. The housing body 306 comprises a bore 307. The bore 307 defines an inner void 308 of the heater 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heating member 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heater element 350 extends in the heater 301. The heater element 350 extends in the elongate housing 302 in the longitudinal direction. The heater element 350 is received in the inner void 308. The heater element 350 extends between the base end 303 and the distal end 304. In embodiments, the heater element 350 extends partially along the length of the inner void 308. In embodiments the heater element 350 extends to or beyond the open end 310.

The heater element 350 in embodiments comprises at least one track of resistive heating material 351. The track of resistive heating material 351comprises a resistive member defining the track of resistive heating material 351. In embodiments the track of resistive heating material 351comprises an electrically insulative coating, such as a ceramic, to electrically insulate the track of resistive heating material 351from the elongate housing 302. The electrically insulative coating in embodiments is thermally conductive to provide for heat transfer from the heater element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heater element 350 to the elongate housing 302.

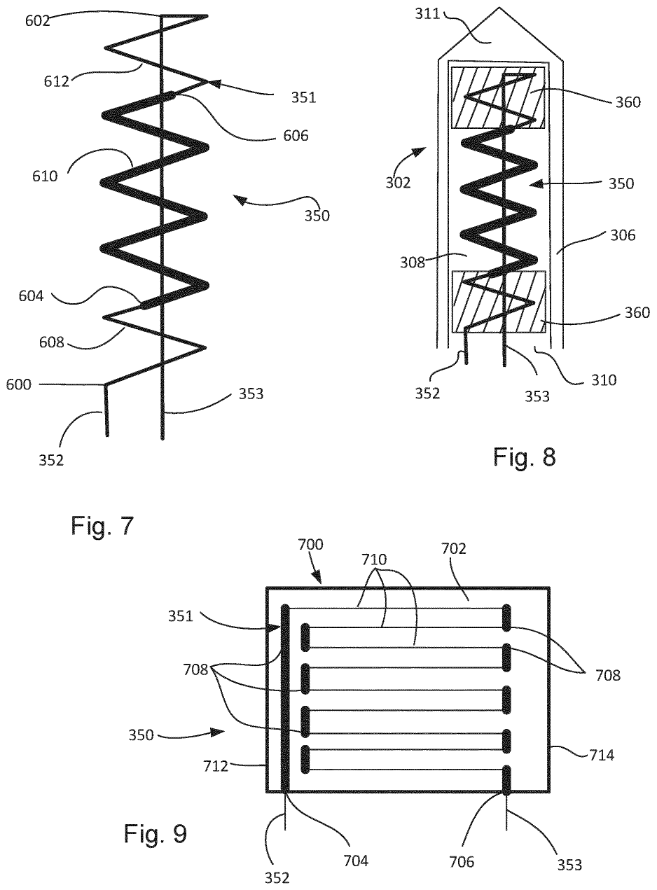

With reference to FIGS. 7 and 8, a first embodiment of the heater element 350 has the form a track of resistive heating material 351formed into a helical coil. The track of resistive heating material 351 extends from a first end 600 to a second end 602 of the coil. The track of resistive heating material 351 is formed from a continuous length of a resistive heating material. A first portion 608 of the helical coil extends from the first end 600 to a first resistance change position 604. The first portion 608 of the helical coil has a circular cross sectional profile with the profile having a diameter D1.

A second portion 610 of the helical coil extends from the first resistance change position 604 to a second resistance change position 606. The second portion 610 of the helical coil has a circular cross-sectional profile with the profile having a diameter D2.

A third portion 612 of the helical coil extends from the second resistance change position 606 to the second end 602. The third portion 612 of the helical coil has circular cross-sectional profile with the profile having a diameter D1.

In some embodiments the diameter D2 is greater than diameter D1 and, as a result, the temperature to which the first and third portions 608, 612 of the helical coil heats are the same as each other and higher than the temperature to which the second portion 610 heats.

In some other embodiments the diameter D2 is less than diameter D1 and, as a result, the temperature to which the first and third portions 608, 612 of the helical coil heats are the same as each other and lower than the temperature to which the second portion 610 heats

In some other, non-illustrated, examples, the third portion 612 has a circular cross sectional profile with a diameter D3. In some embodiments D3 is less than D1 is less than D2. This has the effect that the third portion 612 heats to a temperature higher than the first portion 608, and the first portion 608 heats to a temperature higher than the second portion 610.

In the embodiment shown in FIG. 7 the change in diameter of the continuous length of a resistive heating material at the first and second resistance change positions 604, 606 is a step change. That is, the change in diameter between D1 and D2 takes place over very little of the length of the continuous length of a resistive heating material, for example in less than 1.0 mm.

In other, non-illustrated, examples, the change in between D1 and D2 can be gradual, for example over a distance of at least 1.0 mm, between 1.0 mm and 3.0 mm, or between 1.0 mm and 5.0 mm.

In other, non-illustrated, examples, the first, second and third portions 608, 610, 612 of the heating coil 351 each have a rectangular cross-sectional profile. It will be understood that other coil configurations are possible. In such examples when the change of cross-section is gradual the cross-sectional profile at any point along the gradual change may be the same cross-section profile as at the ends of the gradual change.

The heating element 350 comprises electrical connection paths 352, 353. The electrical connection paths 352, 353 are connected to connectors (not shown) at each end 600, 602 of the track of resistive heating material 351 respectively. A base electrical connection path 352 extends from the distal end of the track of resistive heating material 351. A return electrical connection path 353 extends from the proximal end of the track of resistive heating material 351. The return electrical connection path 353 extends through the spaced defined by the helical coil in a direction approximately parallel to the longitudinal axis of the helical coil. The electrical connection paths 352, 353 are wires that connect into the device and which have a lower resistance than the track of resistive heating material 351 to reduce the heating of device electronics.

In some other, non-illustrated, examples, the return electrical connection path 353 extends outside of the helical coil.

In some other, non-illustrated, examples, the body of the elongate housing 302 constitutes at least part of the return electrical connection path 353.

In non-illustrated embodiments, the electrical connection paths are integrally formed with the track of resistive heating material 351, for example as a single wire.

The track of resistive heating material 351 is formed from a resistive material, such as a nickel/chrome alloy such as nichrome 80/20 (80% Nickel, 20% Chromium), an iron/chrome/aluminium alloy, or a copper/nickel alloy.

The heater element 350 is so configured that the heater element 350 can be placed into the inner void 308 of the elongate housing 302 with only the connection paths 352, 353 extending out of the inner void 308 through mouth end 310 of the housing 302.

With reference to FIG. 8, the heater element 350 is fixed in position in the inner void 308 by masses of filler 360. The masses of filler extend between the inner faces of housing body 306 and surround parts of the heater element 350. The mases of filler material 360 may be a potting compound.

In some other, non-illustrated, examples, there is one mass of filler and that mass fills those parts of the inner void not occupied by the heater element 350 and any electrical connection paths.

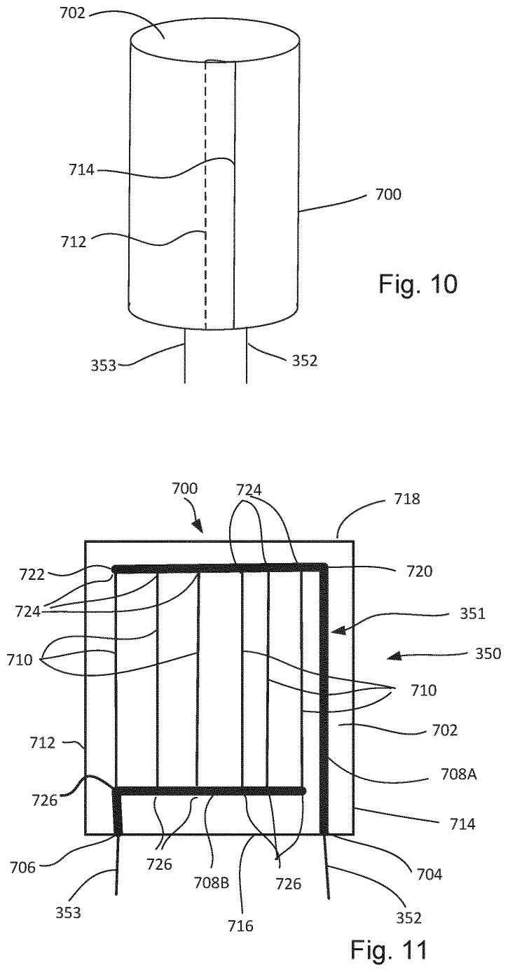

With reference to FIGS. 9 and 10, a second embodiment of the heater element 350 includes a substrate 700 and a continuous track of resistive heating material 351 is supported on a major surface 702 of the substrate 700. FIG. 8 shows the substrate 700 in flat configuration.

The track of resistive heating material 351 extends from a first end 704 to a second end 706. The track of resistive heating material 351 is formed from a plurality of alpha portions 708 and a plurality of beta portions 710, The alpha and beta portions 708, 710 alternate along the length of the track of resistive heating material 351 (for clarity not all of the alpha and beta portions 708, 710 are labelled). The alpha portions 708 have a quadrilateral, for example square, cross-sectional profile with a cross sectional area A1. The beta portions 710 have a rectangular cross-sectional profile with a cross sectional area A2. Cross-sectional area A1 is greater than cross-sectional area A2 and, as a result, the temperature to which the alpha portions 708 heat is lower than the temperature to which the beta portions 710 heat.

In FIG. 9 the change in cross-section of the track of resistive heating material 351 at the intersection of the alpha and beta portions is a step change. That is, the change in cross sectional area between areas A1 and A2 takes place over very little of the length of the track, for example in less than 1.0 mm.

In other, non-illustrated, examples, the change in between cross-sectional areas A1 and A2 can be gradual, for example over a distance of at least 1.0 mm, between 1.0 mm and 3.0 mm, or between 1.0 mm and 5.0 mm.

In other, non-illustrated, examples, the alpha and beta portions 708, 710 each have a circular or other shaped cross-sectional profiles. It will be understood that other configurations of the continuous length of a resistive heating material 351 are possible.

The heating element 350 comprises electrical connection paths 352, 353. The electrical connection paths 352, 353 are connected to connectors (not shown) at each end 704, 706 of the track of resistive heating material 351 respectively. The connection paths are not supported on the substrate 700.

In non-illustrated embodiments, the electrical connection paths are integrally formed with the track of resistive heating material 351, for example as a single ribbon of resistive material, and are supported on the substrate 700.

The track of resistive heating material 351 is formed from a resistive material, such as a nickel/chrome alloy such as nichrome 80/20 (80% Nickel, 20% Chromium), an iron/chrome/aluminium alloy, or a copper/nickel alloy.

The substrate 700 is rolled into a tube (as shown in FIG. 10) with the surface 702 of the substrate 700 on the radially inner face of the tube, and the portion of the substrate 700 adjacent edge 714 of the substrate overlapping the portion of the substrate adjacent edge 712 of the substrate. The connection paths 352, 353 extend from an end of the tube.

The tube is so configured that the tube can be placed into the inner void 308 of the elongate housing 302 with only the connection paths 352, 353 extending out of the inner void 308 through mouth end 310 of the housing 302.

In some other, non-illustrated, examples, where the connection paths are integrally formed with the track of resistive heating material 351 a portion of the tube of the substrate 700 may project from the inner void 308.

With reference to FIG. 11, a third embodiment of the heater element 350 includes a substrate 700 and a continuous track of resistive heating material 351 is supported on a major surface 702 of the substrate 700. The substrate 700 is rectangular with side edges 712 and 714 which are opposite each other and side edges 716 and 718 which are opposite each other.

The track of resistive heating material 351 extends from a first end 704 to a second end 706. The track of resistive heating material 351 is formed from first and second alpha portions 708A, 708B and a plurality of beta portions 710. The alpha portions 708 have a quadrilateral, for example square, cross-sectional profile with a cross sectional area A1. The beta portions 710 have a different quadrilateral, for example rectangular, cross-sectional profile with a cross sectional area A2. Cross-sectional area A1 is greater than cross-sectional area A2 and, as a result, the temperature to which the alpha portions 708 heat is lower than the temperature to which the beta portions 710 heat.

In some other, non-illustrated, examples, the cross-sectional area A1 is less than cross-sectional area A2 and, as a result, the temperature to which the alpha portions 708 heat is higher than the temperature to which the beta portions 710 heat.

First and second ends 704, 705 of the track of resistive heating material 351 are located adjacent edge 716 of the substrate 700 in positions close to but spaced from edges 714, 712 respectively. The alpha portion 708A extends from the first end 704 in a direction approximately parallel to the edge 714 to a position 720 close to but spaced from edge 718. The alpha portion 708A then extends to position 722 in a direction approximately parallel to edge 718. A plurality of beta portions 710 extend from junctions 724 located on the part of the alpha portion 708A between positions 720 and 722.

The alpha portion 708B extends from the second end 706 in a direction approximately parallel to the edge 716 towards the edge 714 but stops at position 728 before it intersects the alpha portion 708A. The alpha portion 708B includes a plurality of junctions 726 between the alpha portion 708B and the beta portions 710.

In FIG. 11 the changes in cross-section of the track of resistive heating material 351 at the junctions 724 and 726 between the alpha and beta portions are step changes. That is, the changes in cross sectional area between areas A1 and A2 takes place over very short distance, for example less than 1.0 mm going from first end 704, the junctions 724 are decreases in cross-sectional area, and the junctions 726 are increases in cross-sectional area.

In other, non-illustrated, examples, the change in between cross-sectional areas A1 and A2 can be gradual, for example over a distance of at least 1.0 mm, between 1.0 mm and 3.0 mm, or between 1.0 mm and 5.0 mm.

In other, non-illustrated, examples, the alpha and beta portions 708, 710 each have a circular or other shaped cross-sectional profiles. It will be understood that other configurations of the continuous length of a resistive heating material 351 are possible.

The heating element 350 comprises electrical connection paths 352, 353. The electrical connection paths 352, 353 are connected to connectors (not shown) at each end 704, 706 of the track of resistive heating material 351 respectively. The connection paths are not supported on the substrate 700.

In non-illustrated embodiments, the electrical connection paths are integrally formed with the track of resistive heating material 351, for example as a single ribbon of resistive material, and are supported on the substrate 700.

The track of resistive heating material 351 is formed from a resistive material, such as a nickel/chrome alloy such as nichrome 80/20 (80% Nickel, 20% Chromium), an iron/chrome/aluminium alloy, or a copper/nickel alloy.

In the same fashion as that described in connection with the embodiment shown in FIGS. 9 and 10, the substrate 700 is rolled into a tube (again as shown in FIG. 10) with the surface 702 of the substrate 700 on the radially inner face of the tube, and the portion of the substrate 700 adjacent edge 714 of the substrate overlapping the portion of the substrate adjacent edge 712 of the substrate. The connection paths 352, 353 extend from an end of the tube.

The tube is so configured that the tube can be placed into the inner void 308 of the elongate housing 302 with only the connection paths 352, 353 extending out of the inner void 308 through mouth end 310 of the housing 302.

In some other, non-illustrated, examples, where the connection paths are integrally formed with the track of resistive heating material 351 a portion of the tube of the substrate 700 may project from the inner void 308.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heater of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat an article containing aerosol generating material, in which the heater comprises:
an elongate housing having a longitudinal axis;
a heater element located in the elongate housing, the heater element comprising a first and a second end, and at least one track of heater material extending between the first end and the second end;
wherein at least a portion of at least one track of heater material includes a change in the electrical resistance of the at least one track.

2. The heater according to claim 1, in which at least one track of the heater material is divided into at least two tracks of heater material for at least a portion of the length of that track.

3. The heater according to claim 2, in which the at least one change of the electrical resistance of the track is so positioned on the track that when the heater element is activated, the heater element creates a predetermined temperature profile along the length of the track.

4. The heater according to claim 1. in which the change in the electrical resistance of the track is the result of a change in a cross-section of the track.

5. The heater according to claim 1, in which there are at least two changes in the electrical resistance of the track.

6. The heater according to claim 1, in which at least one change in electrical resistance is a step change at a single position on the track of heater material.

7. The heater according to claim 1, in which at least one change in electrical resistance is a continuous change over a length of the track of restive material.

8. The heater according to claim 1, in which the heater element further comprises a substrate, and the or each track of heater material is supported on the substrate.

9. The heater according to claim 8, in which the substrate and the or each track of heater material are flexible.

10. The heater according to claim 8, in which the substrate is elastically flexible.

11. The heater according to any of claim 1, in which the housing defines an inner void, and the heater element is so configured that one of at least 75%, at least 80%, at least 90% and 100% of the heater element fits within the inner void.

12. The heater according to claim 11, in which the heater element further comprises a substrate, and the or each track of heater material is supported on the substrate and in which the heater element and substrate are so configured that the substrate urges the or each track of heater material against one or more of the surfaces of the housing that define the inner void.

13. The heater according to claim 11, in which the heater comprises at least one mass of a material; in which the mass of material is positioned within the hollow bore; and the at least one mass of material retains at least part of the heater element in a fixed position relative to the housing.

14. The heater according to claim 11, in which the hollow bore is filled with the mass of material and the whole of the heater element that is located within the hollow bore is retained in a fixed position relative to the housing.

15. The heater according to claim 13, in which the mass of material comprises an adhesive or a potting compound.

16. The heater according to claim 1, in which the heater material is a resistive heater material and the heater is a resistive heater.

17. An aerosol provision device configured to heat an article to generate an aerosol comprising a heater according to claim 1.

18. A system comprising the heater according to claim 1 and an article comprising aerosol generating material.

19. A method of generating aerosol, comprising: providing an aerosol provision device comprising a heater according to claim 1 and a heating chamber including a receiving portion; and at least partially inserting an aerosol generating article into the receiving portion of the heating chamber.

20. The heater according to claim 1, in which the at least one change of the electrical resistance of the track is so positioned on the track that when the heater element is activated, the heater element creates a predetermined temperature profile along the length of the track.
